(19) United States
(12) Patent Application Publication
(10) Pub. No.: US 2025/0390725 A1
(43) Pub. Date: Dec. 25, 2025

(54) ACTIVATION COMPRESSION METHODS FOR COMPRESSING ACTIVATION OF ARTIFICIAL NEURAL NETWORK MODELS, TRAINING METHODS USING THE SAME, RECORDING MEDIA AND COMPUTING DEVICES

(71) Applicant: SEOUL NATIONAL UNIVERSITY R&DB FOUNDATION, Seoul (KR)

(72) Inventors: Dongsuk JEON, Seoul (KR); Sunghyeon WOO, Seoul (KR)

(21) Appl. No.: 19/035,183

(22) Filed: Jan. 23, 2025

(30) Foreign Application Priority Data
Jun. 19, 2024 (KR) 10-2024-0079620

(51) Int. Cl. G06N 3/0495; G06N 3/084

(52) U.S. Cl. CPC G06N 3/0495; G06N 3/084

(57) ABSTRACT

An embodiment relates to an activation compression method including a first step of calculating a sensitivity for each layer of an artificial neural network model, wherein the sensitivity is an indicator of the influence of activations of each layer on training of the artificial neural network model, a second step of allocating bits of each layer depending on the sensitivity calculated in the first step such that a layer with a high sensitivity has higher bits than a layer with a low sensitivity, and a third step of compressing the activations of each layer according to the bits allocated in the second step.

### CROSS-REFERENCE TO RELATED APPLICATION

This application claims priority to Korean Patent Application No. 10-2024-0079620 filed in the Korean Intellectual Property Office on Jun. 19, 2024, the disclosure of which is incorporated by reference herein in its entirety.

### TECHNICAL FIELD

The present disclosure relates to a compression method for solving an activation memory bottleneck problem during training of an artificial neural network model by combining effective activation compression using an average value and a computationally efficient sensitivity analysis method.

### BACKGROUND ART

In recent years, artificial neural network models such as deep learning have achieved remarkable results in language-related tasks by using a large language model (LLM) that performs similarly or even better than humans.

Behind this success lies various efforts to increase the model size, which directly improves performance according to scaling laws. However, since the amount of activation memory required for training also increases proportionally, it is difficult to implement in practice. One of the causes of activation memory bottleneck during training is that the backpropagation algorithm (Kelley, 1960) must store all intermediate activations generated in the forward propagation process in an activation memory, which is later used to calculate a parameter gradient in the backpropagation process.

For example, as shown in FIG. 1, GPT-3 with 175 billion parameters and MT-LNG with 1 trillion parameters require activation memories of 67.3 GB and 132.7 GB, respectively, which exceed the activation memory occupied by the parameters and optimizer states. FIG. 1 shows the activation memory usage of GPT-3 (22B/175B) and MT-LNG (530B/1T) using data and model parallelism, in which the red dotted line represents 80 GB capacity of the NVIDIA A100 GPU.

This problem worsens as the microbatch size or sequence length increases because the memory storing activations also increases proportionally, whereas the activation memory occupied by parameters and optimizer states does not change. Therefore, it is very important to reduce the activation memory when training large language models (LLMs).

The previous studies related to the present disclosure will be described below.

Activation rematerialization (Chen et al., 2016; Jain et al., 2019; Feng & Huang, 2021) and reversible networks (Gomez et al., 2017; Kitaev et al., 2020; Sander et al., 2021; Cai et al., 2023) store only some of the activations and recalculate the rest during the backpropagation process. These methods require additional calculations during the backpropagation process and slow down the training speed.

Reduced-precision training (Micikevicius et al., 2018; Wang et al., 2018; Chen et al., 2020; Sun et al., 2020) aims to reduce computational precision and training memory by representing each variable (e.g., weight, error, activation or gradient) using a low-precision data format such as FP8. However, as the precision decreases, the training accuracy deteriorates rapidly, and optimized kernels for low-precision operations are required to maximize the training speed.

On the other hand, activation-compressed training (ACT) (Chakrabarti & Moseley, 2019; Chen et al., 2021; Liu et al., 2022b; Pan et al., 2021; Liu et al., 2022a) aims only to reduce activation memory usage by compressing activations before storing the same in the forward propagation process. However, the existing ACT methods suffer from significant performance degradation when activations are deeply compressed during training when applied to large language models. For example, MESA (Pan et al., 2021) uniformly compresses activations of all layers with the same compression rate, and the training performance deteriorates noticeably when the activation precision is less than 8 bits. GACT (Liu et al., 2022a) determines the compression rate (i.e., allocated bit precision) on the basis of the sensitivity of each layer and achieves a 4-bit compression rate in the transformer model. However, quantized activations significantly affect the training performance, and the lowest bit precision that can be allocated to a layer with low sensitivity is 1 bit, which limits the flexibility of bit precision allocation and hinders further compression.

### DISCLOSURE

### Technical Problem

The present disclosure has been devised in view of this technical background and aims to solve the memory bottleneck problem during training of artificial neural network models by combining effective activation compression using average values and a computationally efficient sensitivity analysis method.

### Technical Solution

An activation compression method according to an embodiment includes first step S10 of calculating a sensitivity for each layer of an artificial neural network model, wherein the sensitivity is an indicator of the influence of activations of each layer on training of the artificial neural network model, second step S20 of allocating bits of each layer depending on the sensitivity calculated in the first step such that a layer with a high sensitivity has higher bits than a layer with a low sensitivity, and third step S30 of compressing the activations of each layer according to the bits allocated in the second step.

The sensitivity is calculated as a difference between a gradient L2 norm when all layers have been compressed into same bits and a gradient L2 norm when only a specific layer has bits changed.

The first step includes: compressing activations of all layers using a first seed, training the artificial neural network model, and only saving an L2 norm of a parameter gradient of each layer; changing a seed used only for compressing activations of a specific layer among all layers, retraining the artificial neural network model, and only saving the L2 norm of the parameter gradient of each layer, and calculating a sensitivity of the specific layer based on a difference in L2 norm values of the specific layer obtained in the two trainings.

The bits are allocated to each layer based on a greedy algorithm in the second step, and the second step includes i) initializing the bits of each layer, ii) lowering the bits of one layer to minimize an objective function of Mathematical Expression 1 below depending on the sensitivity, iii) checking whether a sum of the reduced bits satisfies a boundary condition of Mathematical Expression 2 below of a memory according to a preset average bit, and iv) repeating i) to iii) until the boundary condition is satisfied if the boundary condition is not satisfied.

The bits are selected from 0.5 bits, 2 bits, 4 bits, and 8 bits, and the third step includes, for layers to which 0.5 bits have been allocated, (a) dividing the activations of each layer into n groups, (b) summing all activations belonging to each group to obtain an average value, and (c) replacing the activations of each group with the obtained average value and compressing the activations.

In the third step, activations belonging to each layer are compressed according to the number of bits allocated to the corresponding layer, for layers to which bits other than 0.5 bits have been allocated.

In another embodiment of the present disclosure, there is disclosed a method of training an artificial neural network model based on the above-described compression method, the method including step (A) of calculating a sensitivity for each layer of the artificial neural network model, wherein the sensitivity is an indicator of the influence of activations of each layer on training of the artificial neural network model, step (B) of allocating bits of each layer depending on the sensitivity calculated in step (A) such that a layer with a high sensitivity has higher bits than a layer with a low sensitivity, step (C) of compressing activations according to bits allocated to each layer of the artificial neural network model in a forward propagation process according to the bits allocated in step (B), and step (D) of restoring the activations compressed and saved in step (C) in a backpropagation process and updating weights.

### Advantageous Effects

The present disclosure can achieve a high compression rate while maintaining model performance by adaptively allocating the number of bits depending on sensitivity in order to minimize gradient variance and using average quantization in order to minimize gradient differences.

### DESCRIPTION OF DRAWINGS

FIG. 1 shows memory usage breakdown of GPT-3 (22B/175B) and MT-LNG (530B/1T) with data and model parallelism.

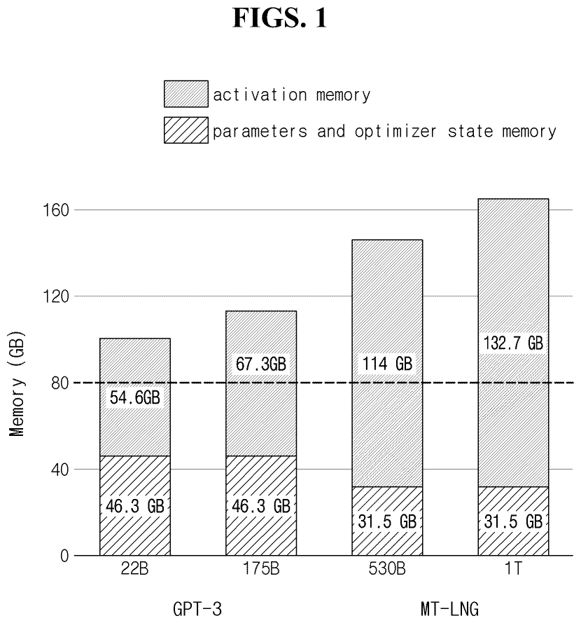

FIG. 2 shows a flow of an activation compression method according to an embodiment.

FIG. 3 shows the overall framework for an artificial neural network model training method according to an embodiment.

FIG. 4 shows a flowchart of the artificial neural network model training method.

FIG. 5 shows a computational device implementing the activation compression method according to an embodiment.

### MODE FOR DISCLOSURE

Hereinafter, embodiments of the present disclosure will be specifically described with reference to the drawings. However, detailed descriptions of known functions or configurations that may obscure the gist of the present disclosure in the following description and the attached drawings will be omitted. In addition, throughout the specification, the term “including” a component does not exclude other components unless specifically stated otherwise, but rather means that other components may be included.

In addition, although the terms “first”, “second”, etc. may be used to describe various components, the components should not be limited by the terms. The terms may be used for the purpose of distinguishing one component from another. For example, without departing from the scope of the present disclosure, a first component may be referred to as a second component, and similarly, the second component may also be referred to as the first component.

The terms used in the present disclosure are used only to describe specific embodiments and are not intended to limit the present disclosure. The singular expression includes the plural expression unless the context clearly indicates otherwise. In this application, the term “comprise” or “include” is intended to specify the presence of a described feature, number, step, operation, component, part, or a combination thereof, but should be understood as not excluding in advance the possibility of the presence or addition of one or more other features, numbers, steps, operations, components, parts, or combinations thereof.

Unless specifically defined otherwise, all terms used herein, including technical or scientific terms, have the same meaning as generally understood by a person of ordinary skill in the art to which the present disclosure belongs. Terms defined in commonly used dictionaries should be interpreted as having a meaning consistent with the meaning they have in the context of the relevant art, and shall not be interpreted in an ideal or excessively formal sense unless explicitly defined in this application.

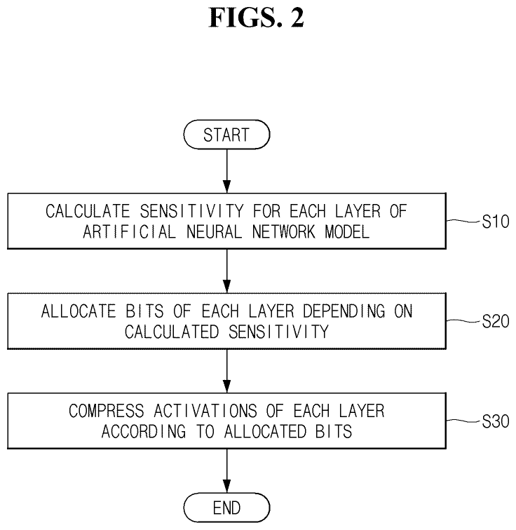

The present disclosure relates to a novel framework that can significantly improve a compression rate while maintaining training performance. The inventors mathematically proved in the paper that compressing activations into their group average values minimizes the gradient variance. By utilizing this property, the present disclosure proposes average quantization (AQ) which provides high-quality deeply compressed activations with an effective precision of less than 1 bit and improves flexibility of precision allocation. In addition, the present disclosure presents a cost-effective yet accurate sensitivity calculation algorithm that solely relies on the L2 norm of parameter gradients, substantially reducing memory overhead due to sensitivity calculation. In experiments, the framework according to the present disclosure significantly reduces activation memory without compromising accuracy, achieving a compression rate of up to 10 times in LLMs An activation compression method according to an embodiment of the present disclosure is as illustrated in FIG. 2. An activation compression method of one embodiment includes a first step (S10) of calculating a sensitivity for each layer of an artificial neural network model, wherein the sensitivity is an indicator of an influence of activations of each layer on training of the artificial neural network model, a second step (S20) of allocating bits of each layer depending on the sensitivity calculated in the first step such that a layer with a high sensitivity has a higher bit than a layer with a low sensitivity, and a third step (S30) of compressing the activations of each layer according to the bits allocated in the second step.

### First Step (S10)

Sensitivity is a measure of the influence of a change in a method of compressing activations of each layer constituting a neural network in an artificial neural network model on the operation of the artificial neural network model. Here, an activation refers to a value that each neuron in a neural network outputs after receiving an input signal and performing a calculation. In the forward pass process of the artificial neural network model, input data is calculated and converted while passing through the neurons of each layer, and the values calculated and output from each neuron at this time are activations.

More specifically, the sensitivity indicates how important activations of each layer play a role in model training. For example, a layer with high sensitivity means that the activations of this layer have a great influence on model training, and a layer with low sensitivity means that the activations of this layer have a relatively small influence on model training.

In the present disclosure, the sensitivity is a criterion for determining the number of bits to be allocated to each layer when compressing activations. In the present disclosure, more bits are allocated to layers with high sensitivity to minimize information loss, and fewer bits are allocated to layers with low sensitivity to maximize a compression rate.

This sensitivity allows the present disclosure to find the optimal balance between model performance and compression rate, and the present disclosure adaptively compresses activations in consideration of sensitivity.

In the present disclosure, the sensitivity is calculated through the GradNorm Var algorithm, which measures the sensitivity of a layer by observing how much the gradient norm of the entire model changes when the activation compression method of each layer changes slightly (e.g., when a different seed is used).

The pseudocode of the GradNorm Var algorithm is shown below. A process of calculating a sensitivity in the present disclosure will be described as follows.

Algorithm 2 Proposed GradNormVar algorithm

```
Require:
  G^{(l)}: L2 norm of parameter gradients g^{(l)} in l-th layer.|
  r₁, r₂: two random seeds
  L: number of layers, [symbol] : elements in l-th layer
  $b = ( b \text{?} ) \text{?} : compression scheme$
Ensure: [symbol]
  : sensitivity of l-th layer
  for l = 1 to L do
    Set r₁ for compressing all activations X, run backprop and store h₀ ← {G^{(l)} = ||g^{(l)}||₂|l ≤ L}
    Change r₁ to r₂ only for compressing l-th activation xₗ, recalculate h₁ ← {G^{(l)} = ||g^{(l)}||₂|l ≤ L}
    $s \text{?} = \frac{1}{2} {‖ {h}_{0} - {h}_{1} ‖}^{2} {( 2 \text{?} - 1 )}^{2}$
  end for [symbol]
indicates data missing or illegible when filed
```

In the present disclosure, the sensitivity is calculated as the difference between a gradient L2 norm when all layers have been compressed into the same bits and a gradient L2 norm when only a specific layer has bits changed.

This will be described more specifically.

The activations of all layers are compressed using the first seed and the artificial neural network model is trained, and only the L2 norm of the parameter gradient of each layer is stored.

The seed used only for compressing the activations of a specific layer among all layers is changed and the artificial neural network model is trained again, and only the L2 norm of the parameter gradient of each layer is stored.

The variance of the difference in the L2 norm values of the specific layer obtained in the two trainings becomes the sensitivity of the corresponding layer.

This sensitivity calculation is performed for all layers of the neural network.

In the present disclosure, since only the L2 norm of the parameter gradient of each layer is used instead of the parameter gradient, the memory usage can be greatly reduced.

For example, if a certain layer has 1,000 parameters, the existing method (GACT) requires storing all 1,000 gradient values. However, in the present disclosure, only the size (L2 norm) of the 1,000 gradient vectors needs to be stored.

### Second Step (S20)

In the second step, bits are allocated to each layer according to the sensitivity of each layer calculated in the first step such that a layer with a high sensitivity has a higher bit than a layer with a low sensitivity.

In one example, 0.5 bits, 2 bits, 4 bits, and 8 bits may be used. The following description is based on this, but the present disclosure is not limited thereto.

The gradient is a value used when updating weights of a model in training, and the model can be trained well only when this gradient is calculated accurately.

When activations are compressed, it naturally affects the calculation of the gradient. Here, it is important to minimize the “variation” of the gradient due to compression. This is because if the variation is large, model training can become unstable.

As announced in the paper (ALAM: AVERAGED LOW-PRECISION ACTIVATION FOR MEMORY-EFFICIENT TRAINING OF TRANSFORMER MODELS), the inventors mathematically analyzed this variation using the concept of “gradient variance” and proved that this gradient variance is minimized when the activations are replaced with the average value.

Simply, unifying all values to a value closest to the average within a group minimizes the variation, and the average value is used in the present disclosure.

For example, if the values of a certain group are [1, 2, 3, 4], and all of these values are replaced with the minimum value 1, they become [1, 1, 1, 1]. Conversely, if all of them are replaced with the maximum value 4, the values become [4, 4, 4, 4]. However, if the values are replaced with the average value 2.5, they become [2.5, 2.5, 2.5, 2.5].

If the differences between the original values of the group and the values after compression are summed,

$$\vert 1 - 1 \vert + \vert 2 - 1 \vert + \vert 3 - 1 \vert + \vert 4 - 1 \vert = 6$$

$$\vert 1 - 4 \vert + \vert 2 - 4 \vert + \vert 3 - 4 \vert + \vert 4 - 4 \vert = 6$$

$$\vert 1 - 2.5 \vert + \vert 2 - 2.5 \vert + \vert 3 - 2.5 \vert + \vert 4 - 2.5 \vert = 4$$

When the average value is used in this manner, the differences are the smallest, and as the differences decrease, an error in gradient calculation can decreases.

Considering this point, the present disclosure compresses a corresponding activation to the average when compressing with a specific bit, which not only reduces the memory usage but also helps to maintain the model training performance as much as possible.

In the present disclosure, bit allocation of each layer based on sensitivity is based on a greedy algorithm. This grid algorithm is a problem-solving method that makes the best choice at each step, makes the best choice in the current situation, and does not consider what effect the choice will have in the future. That is, the grid algorithm is an algorithm that focuses on maximizing immediate profits.

A bit allocation algorithm of the present disclosure based on this grid algorithm is described as follows.

In the present disclosure, the second step is to:
i) initialize the bits of each layer; and
ii) lower the bits of one layer in the direction in which the objective function of Mathematical Expression 1 is minimized according to the sensitivity.

$$Var [ {\hat{∇}}_{θ} ℒ ] \leq {\sum }_{l = 1}^{L} {{c}_{l} ( {2}^{{b}_{l}} - 1 )}^{- 2} \qquad [ Mathematical Expression 1 ]$$

In Mathematical Expression 1, when the gradient when compressed activations are used is Var[\hat{∇}_{θ} [symbol] , L is the total number of layers, cl is the sensitivity of the l-th layer, and bl is the number of bits allocated to the l-th layer.

Through Mathematical Expression 1, it can be ascertained that the gradient variance decreases as activations are less compressed (as bl increases), the smaller the gradient variance becomes, the higher the sensitivity of the layer is, a layer with a high sensitivity has greater influence on the variance, and the upper limit of the overall gradient variance is determined by the sum of the variances of each layer.

In the present disclosure, the number of bits bl of each layer is determined such that this gradient variance is minimized. That is, more bits are allocated to layers with high sensitivity, and fewer bits are allocated to layers with low sensitivity. The second step further includes:
iii) checking whether the sum of the reduced bits satisfies the boundary condition of the following mathematical expression 2 of the memory according to a preset average bit; and

$$( {\sum }_{l = 0}^{L} {b}_{l} {n}_{l} ≦ {B}_{set} {\sum }_{l = 0}^{L} {n}_{l} ) \qquad [ Mathematical Expression 2 ]$$

iv) repeating i) to iii) until the boundary condition is satisfied if the boundary condition is not satisfied.

In other words, bits are allocated differently for each layer to minimize variance from a given average bit (e.g., 1 bit), and the bits are allocated based on Mathematical Expression 2. In Mathematical Expression 2, bl is the number of bits of each layer, Bset is an average bit set by the user, and nl is the size of an activation.

For example, description will be given as follows on the assumption that the sizes (nl) of all activations are the same, there are three layers, and the user sets the average bit to 1 bit.
i) Initially, the bits of all layers are initialized to 8 bits. (8 bits, 8 bits, 8 bits)
ii) In this case, the number of bits of the first layer with the highest sensitivity is lowered to minimize the objective function of Mathematical Expression 1 (8 bits, 8 bits, 8-bit)→(4 bits, 8 bits, 8 bits)
iii) It is checked whether the result satisfies the boundary condition of Mathematical Expression 2. [Check if (4+8+8)<=3*1 holds]
iv) If iii) does not hold, ii) and iii) are repeated.

As a result, the bits become (0.5 bits, 0.5 bits, 2 bits), and if the boundary condition (0.5+0.5+2)<=3*1 is satisfied, compression begins with these bits.

### Third Step (S30)

The third step is a process of compressing the activations of each layer according to the bits allocated in the second step.

In the present disclosure, the activations are compressed using an average low-precision compression algorithm and a general quantization algorithm.

### General Quantization Algorithm

In general quantization, each individual activation is independently compressed according to the bits allocated to a layer.

For example, 8-bit quantization approximates each activation to one of 256 (2\hat{ }8) levels. In this case, each activation occupies 8 bits of memory.

In general quantization, 1 bit is the theoretically available minimum unit, and in this case, each value is expressed as 0 or 1.

### Average Low-Precision Compression Algorithm

In this algorithm, a group average of activations is calculated and this average is quantized.

For example, if four activations are grouped into one group and the average of this group is quantized into 8 bits (the number of bits allocated to a layer), each value is effectively expressed as 2 bits (8 bits/4). This means that at the individual value level, the value is compressed with a precision lower than 2 bits.

Using this algorithm, it is possible to perform compression with a precision lower than 1 bit, for example, “0.5 bits”. This is equivalent to grouping eight values and quantizing the average thereof to 4 bits.

This average low-precision compression algorithm compresses a group of values instead of individual values. This enables ultra-low-precision compression of less than 1 bit. This is a level of compression that cannot be achieved with general quantization.

In addition, this average low-precision compression algorithm minimizes information loss due to compression by using a group average. The inventors mathematically proved that using group averages minimizes gradient variance. This suggests that this average low-precision compression algorithm is an effective compression method for minimizing the influence on model performance.

On the other hand, general quantization compresses individual values independently, and thus compression of less than 1 bit is impossible. In addition, in the case of extreme compression (e.g., 1-bit quantization), information loss is considerably large, which can significantly deteriorate model performance.

In view of this, the present disclosure uses both of these methods. First, the possibility of ultra-low-precision compression is opened using the average low-precision compression algorithm, and then an appropriate precision (number of bits) is allocated depending on the sensitivity of each layer through the greedy algorithm. Layers with low sensitivity (e.g., layers to which 0.5 bits are allocated) are compressed into less than 1 bit using the average low-precision compression algorithm, and for layers with high sensitivity (e.g., layers to which one of 2 bits, 4 bits, or 8 bits is allocated), general quantization is used to maintain sufficient precision.

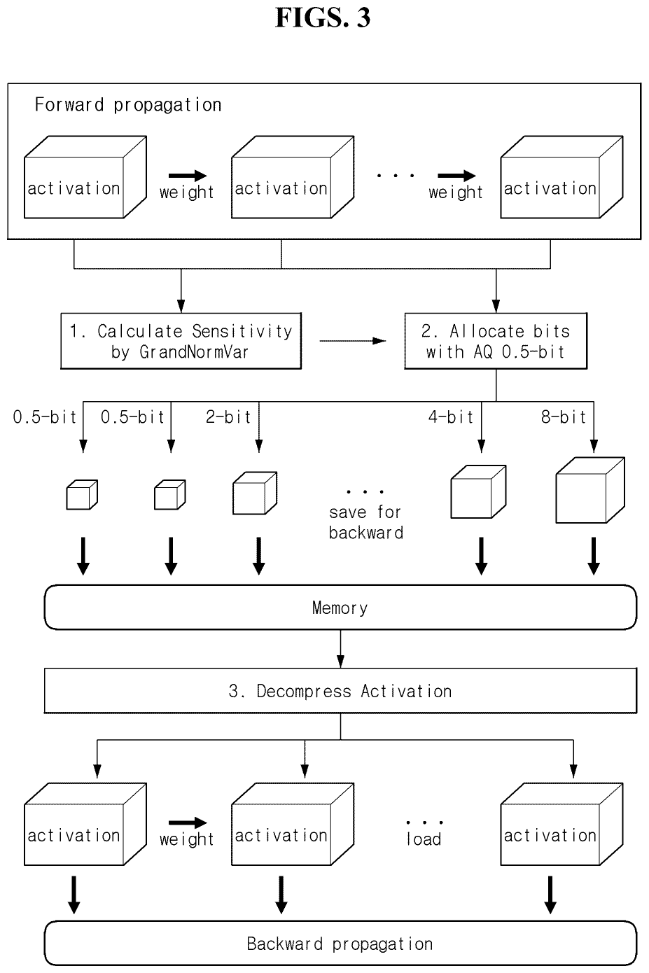

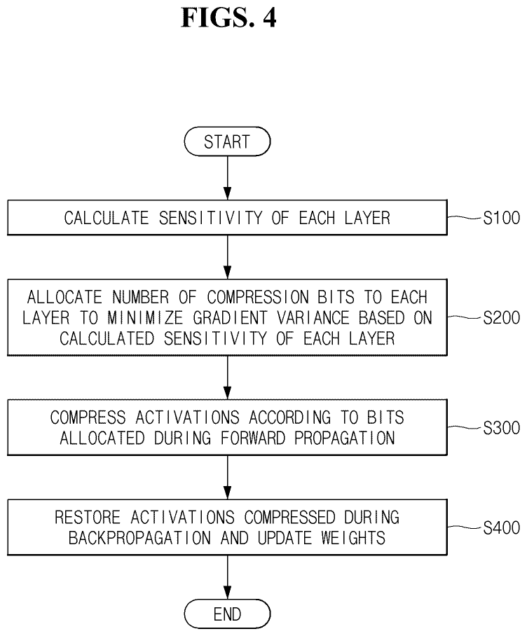

As described above, the present disclosure can achieve a high compression rate while maintaining model performance through two processes of adaptively allocating the number of bits depending on sensitivity in order to minimize gradient variance (S20) and using average quantization in order to minimize gradient differences (S30). Hereinafter, an artificial neural network model training method based on the compression method described above will be described with reference to FIG. 3 and FIG. 4. Here, FIG. 3 shows the overall framework for the training method, and FIG. 4 shows a flowchart of the training method.

The artificial neural network model training method according to the present embodiment includes: step (A) S100 of calculating a sensitivity for each layer of an artificial neural network model, wherein the sensitivity is an indicator of the influence of activations of each layer on training of the artificial neural network model; step (B) S200 of allocating bits of each layer depending on the sensitivity calculated in step (A) such that a layer with a high sensitivity has higher bits than a layer with a low sensitivity; step (C) S300 of compressing activations according to bits allocated to each layer of the artificial neural network model in a forward propagation process based on the bits allocated in step (B); and step (D) S400 of restoring the activations compressed and stored in step (C) in a backpropagation process to update weights.

Here, steps S100 to S300 are substantially the same as steps S10 to S30 described above, and thus will be described in detail here.

The sensitivity is calculated as the difference between a gradient L2 norm when all layers have been compressed into the same bits and a gradient L2 norm when only a specific layer has bits changed.

In step (A), the activations of all layers are compressed with the first seed, the artificial neural network model is trained, only the L2 norm of the parameter gradient of each layer is stored, a seed used only to compress the activations of a specific layer among all layers is changed and the artificial neural network model is retrained, only the L2 norm of the parameter gradient of each layer is stored, and the sensitivity of the specific layer is calculated on the basis of the difference in the L2 norm values of the specific layer obtained in the aforementioned two trainings. This process is repeated equally for all layers of the neural network.

In step (B), the bits are allocated to each layer on the basis of a greedy algorithm, wherein step (B) includes i) initializing the bits of each layer, ii) lowering the bits of one layer to minimize the objective function of Mathematical Expression 1 depending on the sensitivity, iii) checking whether the sum of the reduced bits satisfies the boundary condition of Mathematical Expression 2 of the memory according to preset average bits, and iv) repeating i) to (iii) until the boundary condition is satisfied if the boundary condition is not satisfied. The bits may be selected from 0.5 bits, 2 bits, 4 bits, and 8 bits.

In step (C), for layers to which 0.5 bits have been allocated, (a) the activations of each layer are divided into n groups, (b) all the activations belonging to each group are summed to obtain an average value, and (c) the activations of each group are replaced with the obtained average value and compressed.

In process (a), adjacent activations may be grouped together.

In step (C), for layers to which bits other than 0.5 bits have been allocated, the activations belonging to each layer are compressed in accordance with the number of bits allocated thereto. Another embodiment of the present disclosure relates to a computational device that implements the above-described activation compression method.

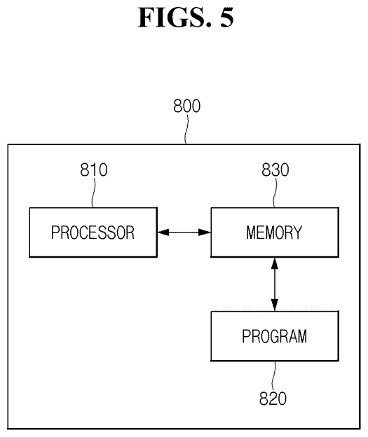

FIG. 5 is a block diagram showing a schematic configuration of the computational device in which a series of components described above is reconstructed from the perspective of hardware configuration. Therefore, in order to avoid redundant description, only an outline of functions and operations of each component will be briefly described here.

The computational device 800 includes a memory 830 in which a program 820 coded to enable a computer to read the activation compression method described above through FIG. 2 is stored, and a processor 810 that executes the program.

Here, the activation compression method includes first step S10 of calculating a sensitivity for each layer of an artificial neural network model, wherein the sensitivity is an indicator of the influence of activations of each layer on training of the artificial neural network model, second step S20 of allocating bits of each layer depending on the sensitivity calculated in the first step such that a layer with a high sensitivity has higher bits than a layer with a low sensitivity, and third step (S30) of compressing the activations of each layer according to the bits allocated in the second step.

The sensitivity is calculated as the difference between a gradient L2 norm when all layers have been compressed into the same bits and a gradient L2 norm when only a specific layer has bits changed.

The first step includes compressing the activations of all layers with a first seed, training the artificial neural network model, saving only the L2 norm of the parameter gradient of each layer, changing a seed used only to compress the activations of a specific layer among all layers, retraining the artificial neural network, saving only the L2 norm of the parameter gradient of each layer, and calculating a sensitivity of the specific layer on the basis of the difference in the L2 norm values of the specific layer obtained in the two trainings.

In the second step, the bits are allocated to each layer on the basis of a greedy algorithm, wherein the second step includes i) initializing the bits of each layer, ii) lowering the bits of one layer to most greatly reduce the objective function of Mathematical Expression 1 depending on the sensitivity, iii) checking whether the sum of the reduced bits satisfies the boundary condition of Mathematical Expression 2 of the memory according to preset average bits, and iv) repeating i) to iii) until the boundary condition is satisfied if the boundary condition is not satisfied.

The bits are selected from 0.5 bits, 2 bits, 4 bits, and 8 bits, and in the third step, for layers to which 0.5 bits have been allocated, (a) the activations of each layer are divided into n groups, (b) all activations belonging to each group are summed to obtain an average value, and (c) the activations of each group are replaced with the obtained average value and compressed.

In the third step, for layers to which bits other than 0.5 bits have been allocated, the activations belonging to each layer are compressed according to the number of bits allocated thereto.

Meanwhile, the above-described activation compression method can be implemented as computer-readable code on a computer-readable recording medium. A computer-readable recording medium includes all types of recording devices that store data that can be read by a computer system.

Examples of a computer-readable recording medium include a ROM, a RAM, a CD-ROM, a magnetic tape, a floppy disk, an optical data storage device, etc. In addition, a computer-readable recording medium can be distributed to a computer system connected to a network, and thus computer-readable code can be stored and executed in a distributed manner. In addition, functional programs, codes, and code segments for implementing the present disclosure can be easily inferred by programmers in the technical field to which the present disclosure belongs.

The present disclosure has been described above with a focus on various embodiments. Those skilled in the art will understand that the present disclosure can be implemented in a modified form without departing from the essential characteristics of the present disclosure. Therefore, the disclosed embodiments should be considered from an illustrative rather than a limiting perspective. The scope of the present disclosure is indicated by the claims, not the foregoing description, and all differences within the scope equivalent thereto should be construed as being included in the present disclosure.

1. An activation compression method comprising:
a first step of calculating a sensitivity for each layer of an artificial neural network model, wherein the sensitivity is an indicator of the influence of activations of each layer on training of the artificial neural network model;
a second step of allocating bits of each layer depending on the sensitivity calculated in the first step such that a layer with a high sensitivity has higher bits than a layer with a low sensitivity; and
a third step of compressing the activations of each layer according to the bits allocated in the second step.

2. The activation compression method of claim 1, wherein the sensitivity is calculated as a difference between a gradient L2 norm when all layers have been compressed into same bits and a gradient L2 norm when only a specific layer has bits changed.

3. The activation compression method of claim 2, wherein the first step comprises:
compressing activations of all layers using a first seed, training the artificial neural network model, and only saving an L2 norm of a parameter gradient of each layer;
changing a seed used only for compressing activations of a specific layer among all layers, retraining the artificial neural network model, and only saving the L2 norm of the parameter gradient of each layer, and
calculating a sensitivity of the specific layer based on a difference in L2 norm values of the specific layer obtained in the two trainings.

4. The activation compression method of claim 1, wherein the bits are allocated to each layer based on a greedy algorithm in the second step.

5. The activation compression method of claim 4, wherein the second step comprises:
i) initializing the bits of each layer;
ii) lowering the bits of one layer to minimize an objective function of Mathematical Expression 1 below depending on the sensitivity;
iii) checking whether a sum of the reduced bits satisfies a boundary condition of Mathematical Expression 2 below of a memory according to a preset average bit; and
iv) repeating i) to iii) until the boundary condition is satisfied if the boundary condition is not satisfied.

6. The activation compression method of claim 1, wherein the bits are selected from 0.5 bits, 2 bits, 4 bits, and 8 bits.

7. The activation compression method of claim 6, wherein the third step comprises:
for layers to which 0.5 bits have been allocated,
(a) dividing the activations of each layer into n groups;
(b) summing all activations belonging to each group to obtain an average value; and
(c) replacing the activations of each group with the obtained average value and compressing the activations.

8. The activation compression method of claim 6, wherein the third step comprises compressing activations belonging to each layer according to the number of bits allocated to the corresponding layer, for layers to which bits other than 0.5 bits have been allocated.

9. A method of training an artificial neural network model, the method comprising:
step (A) of calculating a sensitivity for each layer of the artificial neural network model, wherein the sensitivity is an indicator of the influence of activations of each layer on training of the artificial neural network model;
step (B) of allocating bits of each layer depending on the sensitivity calculated in step (A) such that a layer with a high sensitivity has higher bits than a layer with a low sensitivity;
step (C) of compressing activations according to bits allocated to each layer of the artificial neural network model in a forward propagation process according to the bits allocated in step (B); and
step (D) of restoring the activations compressed and saved in step (C) in a backpropagation process and updating weights.

10. The method of claim 9, wherein the sensitivity is calculated as a difference between a gradient L2 norm when all layers have been compressed into same bits and a gradient L2 norm when only a specific layer has bits changed.

11. The method of claim 10, wherein step (A) comprises:
compressing activations of all layers using a first seed, training the artificial neural network model, and only saving an L2 norm of a parameter gradient of each layer;
changing a seed used only for compressing activations of a specific layer among all layers, retraining the artificial neural network model, and only saving the L2 norm of the parameter gradient of each layer, and
calculating a sensitivity of the specific layer based on a difference in L2 norm values of the specific layer obtained in the two trainings.

12. The method of claim 9, wherein the bits are allocated to each layer based on a greedy algorithm in step (B).

13. The method of claim 12, wherein step (B) comprises:
i) initializing the bits of each layer;
ii) lowering the bits of one layer to minimize an objective function of Mathematical Expression 1 depending on the sensitivity;
iii) checking whether a sum of the reduced bits satisfies a boundary condition of Mathematical Expression 2 of a memory according to a preset average bit; and
iv) repeating i) to iii) until the boundary condition is satisfied if the boundary condition is not satisfied.

14. The method of claim 9, wherein the bits are selected from 0.5 bits, 2 bits, 4 bits, and 8 bits.

15. The method of claim 14, wherein step (C) comprises:
for layers to which 0.5 bits have been allocated,
(a) dividing the activations of each layer into n groups;
(b) summing all activations belonging to each group to obtain an average value; and
(c) replacing the activations of each group with the obtained average value and compressing the activations.

16. The method of claim 15, wherein step (C) comprises compressing activations belonging to each layer according to the number of bits allocated to the corresponding layer, for layers to which bits other than 0.5 bits have been allocated.

17. A computational device comprising:
a memory in which a program coded to allow a computer to read the activation compression method is stored; and
a processor configured to execute the program,
wherein the activation compression method comprises:
a first step of calculating a sensitivity for each layer of an artificial neural network model, wherein the sensitivity is an indicator of the influence of activations of each layer on training of the artificial neural network model;
a second step of allocating bits of each layer depending on the sensitivity calculated in the first step such that a layer with a high sensitivity has higher bits than a layer with a low sensitivity; and
a third step of compressing the activations of each layer according to the bits allocated in the second step.

18. The computational device of claim 17, wherein the first step comprises:
compressing activations of all layers using a first seed, training the artificial neural network model, and only saving an L2 norm of a parameter gradient of each layer;
changing a seed used only for compressing activations of a specific layer among all layers, retraining the artificial neural network model, and only saving the L2 norm of the parameter gradient of each layer, and
calculating a sensitivity of the specific layer based on a difference in L2 norm values of the specific layer obtained in the two trainings.

19. The computational device of claim 17, wherein the bits are allocated to each layer based on a greedy algorithm in the second step, and
wherein the second step comprises:
i) initializing the bits of each layer;
ii) lowering the bits of one layer to minimize an objective function of Mathematical Expression 1 below depending on the sensitivity;
iii) checking whether a sum of the reduced bits satisfies a boundary condition of Mathematical Expression 2 below of a memory according to a preset average bit; and
iv) repeating i) to iii) until the boundary condition is satisfied if the boundary condition is not satisfied.

20. The computational device of claim 17, wherein the bits are selected from 0.5 bits, 2 bits, 4 bits, and 8 bits, and
wherein the third step comprises:
for layers to which 0.5 bits have been allocated,
(a) dividing the activations of each layer into n groups;
(b) summing all activations belonging to each group to obtain an average value; and
(c) replacing the activations of each group with the obtained average value and compressing the activations.
